(19) United States
(12) Patent Application Publication
(10) Pub. No.: US 2010/0186536 A1
(43) Pub. Date: Jul. 29, 2010

(54) STEERING COLUMN MEMORY MECHANISM

(75) Inventor: Mark A. Cartwright, West Lafeyette, IN (US)

Correspondence Address: TAROLLI, SUNDHEIM, COVELL & TUMMINO L.L.P., 1300 EAST NINTH STREET, SUITE 1700, CLEVELAND, OH, 44114, US

(73) Assignee: TRW Automotive U.S. LLC

(21) Appl. No.: 12/362,029

(22) Filed: Jan. 29, 2009

(51) Int. Cl. B62D 1/184

(52) U.S. Cl. 74/495

(57) ABSTRACT

A steering column (10) for a vehicle includes a steering column member (12) and a mounting bracket (54). A support (24) is connected with the mounting bracket (54) and supports the steering column member (12) for rotation about a longitudinal axis (26). The support (24) is movable relative to the mounting bracket (54) into any one of a plurality of positions. A locking mechanism (110) locks the support (24) in any one of the plurality of positions relative to the mounting bracket (54). A memory mechanism (130) spaced from the locking mechanism (110) permits movement of the mounting bracket (54) relative to the vehicle frame between a first position and a second position. The memory mechanism (130) guides movement of the mounting bracket (54) relative to the vehicle frame between the first position and the second position.

### FIELD OF THE INVENTION

The present invention relates to an adjustable steering column, and more specifically, to a memory mechanism for an adjustable steering column.

### BACKGROUND OF THE INVENTION

An adjustable steering column for a vehicle generally includes a steering column member connectable with a steering wheel. The steering column member extends through a support. A locking mechanism locks the support in any one of a plurality of positions relative to a mounting bracket. An operator of the vehicle may move the support to a desired position relative to the mounting bracket. The steering column does not include a mechanism that allows the operator to move the support and mounting bracket as a unit once the support is locked in the desired position such that ingress and egress into the vehicle can be facilitated.

### SUMMARY OF THE INVENTION

A steering column of the present invention includes a steering column member and a mounting bracket. A support is connected with the mounting bracket and supports the steering column member for rotation about a longitudinal axis. The support is movable relative to the mounting bracket into any one of a plurality of positions. A locking mechanism locks the support in any one of the plurality of positions relative to the mounting bracket. A memory mechanism spaced from the locking mechanism permits movement of the mounting bracket relative to the vehicle frame between a first position and a second position. The memory mechanism guides movement of the mounting bracket relative to the vehicle frame between the first position and the second position.

In another aspect of the present invention a steering column for a vehicle includes a steering column member connectable with a steering wheel and rotatable to turn steerable vehicle wheels. A mounting bracket includes slots, each slot having a first notch and a second notch spaced from the first notch. A support is connected with the mounting bracket and the steering column member extends through the support. A memory mechanism includes a base member connecting the mounting bracket to a vehicle frame and an actuator pivotally mounted to the base member. The actuator has a pin positioned within each slot on the mounting bracket. The pins move along the slots to allow the mounting bracket to move relative to the base member. The pins engage the first notches of the slots to lock the mounting bracket in a first position abutting the base member. The pins engage the second notches of the slots to lock the mounting bracket in a second position spaced from the base member and different from the first position. The actuator is pulled away from the mounting bracket to move the pins out of engagement with the first or second notches of the slots to permit movement of the mounting bracket between the first position and the second position.

### BRIEF DESCRIPTION OF THE DRAWINGS

The foregoing and other features of the present invention will become apparent to one skilled in the art to which the present invention relates upon consideration of the following description of the invention with reference to the accompanying drawings, in which:

FIG. 1 is a schematic view of a steering column having a memory mechanism constructed in accordance with the present invention;

FIG. 2 is a bottom view of the steering column of FIG. 1;

FIG. 3 is an exploded view of the memory mechanism of FIG. 1;

FIG. 4 is a side view of the steering column of FIG. 1 in a driving position; and

FIG. 5 is a side view of the steering column of FIG. 1 in a second position.

### DESCRIPTION OF THE INVENTION

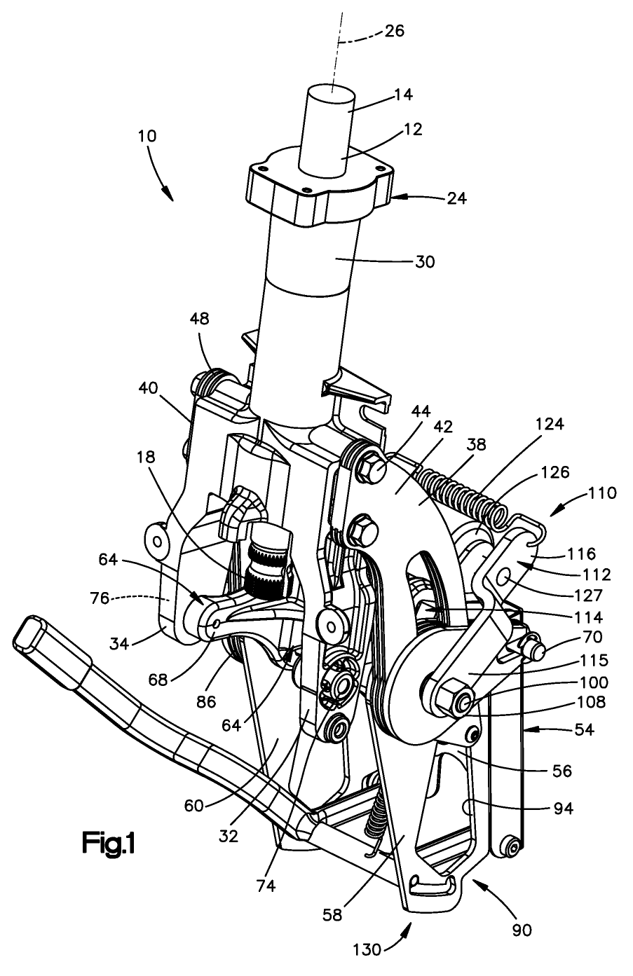

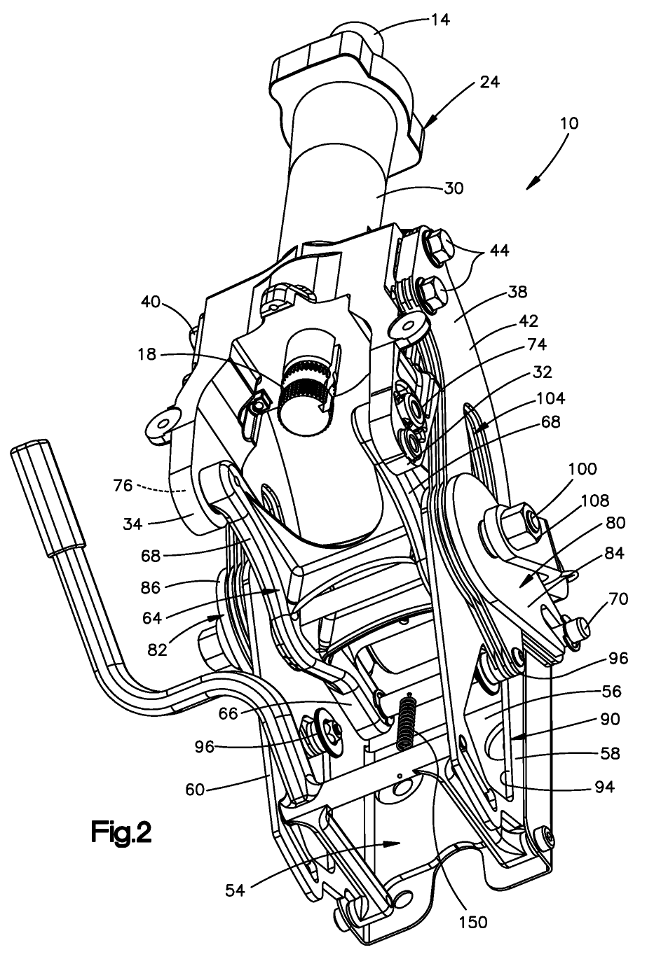

A vehicle steering column 10 is illustrated in FIGS. 1-2. The steering column 10 may be generally similar to the steering column described in U.S. Pat. No. 6,952,979, which is incorporated herein by reference in its entirety. The steering column 10 includes a rotatable steering column member 12 to turn steerable vehicle wheels (not shown). The steering column member 12 has an end 14 connectable with a steering wheel (not shown) in any suitable manner. An end 18 of the steering column member 12 opposite from the end 14 is connectable with a universal joint (not shown). The universal joint connected with the end 18 of the steering column member 12 is connectable with a mechanism designed to transmit movement of the steering column member to a steering gear and permit movement of the steering column member relative to the mechanism, in any suitable manner.

A support 24 supports the steering column member 12 for rotation about a longitudinal axis 26 of the steering column member. Upon rotation of the steering wheel, the steering column member 12 rotates about the longitudinal axis 26. Upon rotation of the steering column member 12 about the longitudinal axis 26, steerable vehicle wheels (not shown) are turned in any suitable manner.

The support 24 may have a tubular portion 30 with a passage through which the steering column member 12 extends. Arm portions 32 and 34 may extend from the tubular portion 30. The tubular portion 30 may be made by casting and may have any desired shape. Bearings in the support 24 may support the steering column member 12 for rotation relative to the support.

The support 24 may include locking portions 38 and 40 extending axially from opposite sides of the tubular portion 30. The locking portion 38 may include a plurality of plates 42 fixedly connected to each other with spacers between them. Although the locking portion 38 is shown as having three plates, it is contemplated that the locking portion may include any desired number of plates. The locking portion 38 may be fixedly connected to the tubular portion 30 by fasteners 44, such as screws.

The locking portion 40 may be identical to locking portion 38 and therefore, will not be described in detail. The locking portion 40 may include a plurality of plates 48 fixedly connected to each other with spacers between them. Although the locking portion 40 is shown as having three plates, it is contemplated that the locking portion may include any desired number of plates. The locking portion 40 may be fixedly connected to the tubular portion 30 by fasteners (not shown), such as screws.

The mounting bracket 54 may include a rear wall 56. Side walls 58 and 60 may be connected to the rear wall 56. The side walls 58 and 60 may extend generally perpendicular to the rear wall 56 and parallel to each other.

A pivot member 64 may interconnect the support 24 and the mounting bracket 54. The pivot member 64 may have a pair of arms 66 (one of which is shown in FIG. 2) extending from one side of the pivot member toward the rear wall 56. The arms 66 may be pivotally connected to the side walls 58 and 60. A pair of arms 68 extending from an opposite side of the pivot member 64 away from the rear wall 56 may be pivotally connected with the support 24.

A pivot shaft 70 may extend through the arms 66 of the pivot member 64. The shaft 70 may be received in openings in the side walls 58 and 60 to pivotally connect the pivot member 64 to the mounting bracket 54. Accordingly, the pivot member 64 may pivot relative to the mounting bracket 54.

A pin 74 may pivotally connect one of the arms 68 of the pivot member 64 to the support 24. The pin 74 may extend through an opening in the arm portion 32 of the support 24 and into an opening in the arm 68 (not shown). A pin 76 may pivotally connect the other arm 68 of the pivot member 64 with the arm portion 34 of the support 24. The pin 76 may extend through an opening in the arm portion 34 of the support 24 and into an opening in the other arm 68. Accordingly, the support 24 may pivot relative to the pivot member 64.

A pair of identical arms 80, 82 may be provided to further interconnect the support 24 and the mounting bracket 54. The arm 80 includes a plurality of plates 84 positioned near the side wall 58 of the mounting bracket 54 and fixedly connected together with a washer between them. The plates 84 extend between the plates 42 of the locking portion 38 of the support 24 and are rotatably mounted to the shaft 70. The arm 82 includes a plurality of plates 86 positioned near the side wall 60 of the mounting bracket 54 and fixedly connected together with a washer between them. The plates 84 extend between the plates 42 of the locking portion 38 of the support 24 and are rotatably mounted to the shaft 70.

A mechanism 90 may define a range of motion of the support 24 relative to the mounting bracket 54. The mechanism 90 may include an opening 94 in the side wall 58 of the mounting bracket 54 into which a guide portion 96 of the support 24 extends. The guide portion 96 may engage surfaces defining the opening 94 to define the limits of movement of the support 24 relative to the mounting bracket 54. The opening 94 may have any desired shape. Accordingly, the opening 94 may define the range of motion, i.e., a plurality of positions, over which the support 24 may move relative to the mounting bracket 54. It is contemplated that any suitable mechanism may be used to define the range of motion.

An exemplary locking mechanism 110 may lock the pivot member 64 in any one of a plurality of pivot positions relative to the mounting bracket 54. The locking mechanism 110 may also lock the support 24 in any one of a plurality of pivot positions relative to the pivot member 64. The locking mechanism 110 may apply a force to clamp the side wall 58 between the pivot member 64 and the locking portion 38 of the support 24. The locking mechanism 110 may also clamp the side wall 60 between the pivot member 64 and the locking portion 40 of the support 24.

A locking shaft 100 may extend through openings (not shown) in the plates 86 of the arm 82, slots (not shown) in the plurality of plates 48 of the locking portion 40, and through the side wall 60 of the mounting bracket 54 and be prevented from rotating relative to the locking portion and the side wall. The pivot member 64 may have a slot through which the locking shaft 100 extends to permit movement of the pivot member relative to the locking shaft. The locking shaft 100 may also extend through the side wall 58, slots 104 in the plurality of plates 42 of the locking portion 38 of the support 24, and openings (not shown) in the plates 84 of the arm 80 and be prevented from rotating relative to the side wall and the locking portion. A nut 108 may be threaded onto the locking shaft 100.

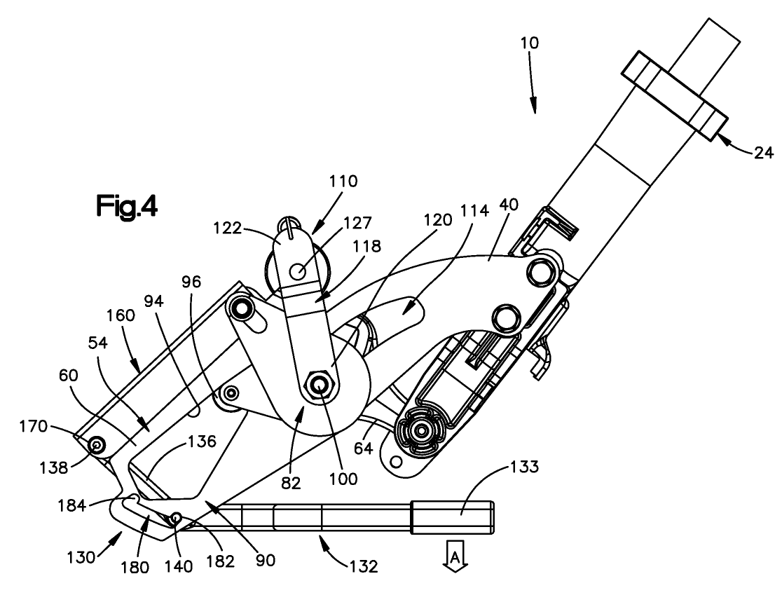

The locking mechanism 110 may include locking levers 112, 118 that apply a force to the plates 42, 48 of the locking portions 38, 40 of the support 24 (see FIG. 1 and FIG. 4). The locking lever 112 has an end 115 with an opening through which the locking shaft 100 extends and an end 116 connected with a piston 127 extending into a cylinder 126. The locking lever 118 has an end 120 with an opening through which the locking shaft 100 extends and an end 122 connected with the cylinder 126.

One or more coil springs 124 extend between the ends 116,122 of the locking levers 112, 118. The spring 124 applies a force to pull the end 116 of the locking lever 112 toward the end 122 of the locking lever 118 to move the ends 115,120 of the locking levers towards one another. Accordingly, the end 115 of the locking lever 112 applies a force to the plates 84 of the arm 80 and, thus, the plates 42 of the locking portion 38 to clamp the plates 84 to the plates 42 and the side wall 58 of the mounting bracket 54 between the pivot member and the support 24. The end 120 of the locking lever 118 likewise applies a force to the plates 86 of the arm 82 and, thus, the plates 48 of the locking portion 40 to clamp the plates 86 to the plates 48 and the side wall 60 of the mounting bracket 54 between the pivot member 64 and the locking portion of the support 24. This biasing force of the spring 124 thereby prevents pivotal movement of the pivot member 64 relative to the mounting bracket 54 and pivotal movement of the support 24 relative to the pivot member.

The cylinder 126 has a port (not shown) for receiving a pressurized fluid, such as air. The pressurized fluid moves the piston 127 and the cylinder 126 relative to each other against the force of the spring 124. Accordingly, when the pressurized fluid is applied to the piston 127, the ends 116, 122 of the locking levers 112,118 are forced apart from one another, thereby releasing the force applied by the spring 124 to allow the support 24 to be positioned relative to the mounting bracket 54.

After the support 24 is moved to a desired position, the pressurized fluid is removed from the cylinder 126. This allows the spring 124 to again apply the force to the plates 84, 86 to lock the support 24 relative to the mounting bracket 54. Although the locking mechanism is described as using a cylinder and spring construction, those having ordinary skill will appreciate that any desired locking mechanism may be used to prevent movement of the support 24 relative to the mounting bracket 54.

Once the support 24 is locked in the desired position relative to the mounting bracket 54, it may be desirable to move the mounting bracket and, thus, the locked support 24 and steering wheel, relative to the vehicle frame. For example, the operator of the vehicle may wish to move the mounting bracket 54 and support 24 to a position in which ingress and egress of the vehicle is facilitated. In order to accomplish this relative movement between the mounting bracket 54 and the vehicle frame, a memory mechanism may be provided.

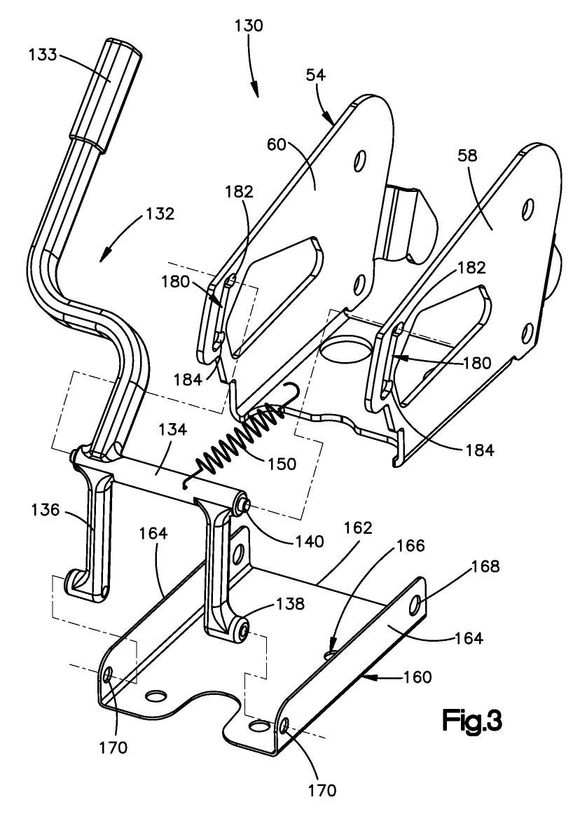

A first exemplary embodiment of a memory mechanism 130 is illustrated in FIG. 3. By “memory mechanism”, it is meant that the mechanism acts to position the mounting bracket relative to the vehicle frame in any number of predetermined locations. For example, the memory mechanism 130 may define a first or driving position of the mounting bracket 54 relative to the vehicle frame and a second or stored position. The second position may be any one of a plurality of positions of the mounting bracket 54 relative to the vehicle frame that is different than the first position.

The memory mechanism 130 guides movement of the mounting bracket 54 between the first or driving position in which the support 24 and, thus, the steering wheel, is located close to the operator for operation of the vehicle, and the second or stored position in which the support and steering wheel are located farther from the operator and closer to the vehicle dashboard for ingress and egress from the vehicle.

The memory mechanism 130 includes a lever or actuator 132 and a base member 160 that connects the mounting bracket 54 to the vehicle frame. The base member 160 is generally rectangular and may be constructed of any rigid material such as plastics, metals or composites thereof. The base member 160 includes a planar base 162 and a pair of side walls 164 that extend substantially perpendicular to the base. Together, the base 162 and the side walls 164 form a generally U-shaped profile.

The base 162 includes at least one mounting hole 166 for receiving a fastener to secure the base member 160 to the vehicle frame. The rear wall 56 of the mounting bracket 54 may include corresponding openings 57 such that the fasteners can be placed through the openings in the wall and the mounting holes 166 in the base member 160 to secure the base member to the vehicle frame (see FIG. 2).

Each of the side walls 164 includes an opening 168 for receiving the pivot shaft 70. Since the pivot shaft 70 extends through the walls 58, 60 of the mounting bracket 54, the pivot member 64, the arms 80, 82, and the side walls 164 of the base member 160, the mounting bracket, pivot member, arms 80, 82, and base member 160 are connected to one another. Furthermore, since the base member 160 is rigidly fixed to the vehicle frame and the mounting bracket 54 and base member 160 share a connection at the pivot shaft 70, the mounting bracket 54 is pivotable about the pivot shaft relative to the base member 160. The side walls 164 of the base member 160 further include openings 170 for receiving portions of the actuator 132, as will be hereafter described.

The actuator 132 is connected to the base member 160 and the mounting bracket 54 for controlling movement of the mounting bracket 54 relative to the base member and, thus, the vehicle frame. The actuator 132 has a generally h-shaped construction and includes a handle 133, a connecting member 134, and a pair of legs 136 extending from the connecting member. Each leg 136 is substantially parallel to the other and extends downward from the connecting member 134. The legs 136 each include a projection 138 extending substantially parallel to the connecting member 134. The projections 138 are sized to extend through the openings 170 in the side walls 164 of the base 162 to connect the actuator 132 to the base member 160. The actuator 132 is constructed of rigid materials such as plastics, metals, and combinations thereof.

The projections 138 are configured with the openings 170 in the base member 160 such that the actuator 132 is pivotally mounted to the base member. In particular, bearings, fasteners, etc. may be used to secure the projections 138 within the openings 170 in the side walls 164 of the base member 160 such that the actuator 132 is rotatable relative to the base member about the projections.

The handle 133 extends from the connecting member 134 and away from the legs 136. The handle 133 is constructed for easy grasping and articulation by the operator and is manipulated by the operator to rotate the actuator 130 about the projections 138 relative to the base member 160.

Each end of the connecting member 134 includes a pin 140 for connecting the actuator 132 to the mounting bracket 54. In particular, the pins 140 extend into slots 180 in the mounting bracket 54 (FIGS. 3-4) for guiding relative movement between the mounting bracket and the actuator 132. Each slot 180 extends through a respective side wall 58, 60 of the mounting bracket 54 and includes a first notch 182 and a second notch 184 spaced from the first notch. The first notch 182 and the second notch 184 have a geometry that differs from the geometry of the remainder of the slot between the first notch and the second notch. In particular, the first notch 182 and the second notch 184 may have a circular or rounded construction that extends outward relative to the remainder of the slot 180 between the first notch and the second notch. Alternatively, the first and second notches 182, 184 may have a narrower or otherwise constricted width relative to the remainder of the slots 180.

In order to position the pins 140 within the slots 180, the pins may be moveable into and out of the connecting member 134 and have a biased construction. In particular, the pins 140 may be disposed within a channel in the connecting member 134 (not shown) and extend outward away from the connecting member. A spring (not shown) within the channel may bias the pins 140 in a direction outward of the connecting member 134. If an inward force applied to the pins 140 exceeds the spring bias, the pins will move inward along the channel and towards one another. This inward movement allows the pins 140 to fit between the side walls 58, 60 of the mounting bracket 54. Once the pins 140 are aligned with the first notches 182 of the slots 180, the radially inward force can be released to allow the spring to bias the pins outward and into the first notches.

In this position, the pins 140 engage the surfaces of the side walls 58, 60 of the mounting bracket 54 defining the first notches 182 of the slots 180 to lock the actuator 132 relative to the mounting bracket. Between the pins 140 and the projections 138, the actuator 132 is connected to both the base member 160 and the mounting bracket 54. Due to the construction of the first notches 182 of the slots 180, the pins 140 become locked within the first notches under the frictional engagement between the pins and the surfaces of the side walls 58, 50 defining the first notches.

The locked connection between the pins 140 and the first notches 182 of the slots 180 prevents the actuator 132 from moving relative to the mounting bracket 54 and, thus, from pivoting about the projections 138 relative to the base member 160. When the pins 140 are locked with the first notches 182 of the slots 180, the mounting bracket 54 is in a first, driving position in close proximity with, or abutting, the base member 160 (FIG. 4).

A spring 150 may be provided to urge the actuator 132 towards the vehicle frame and therefore urge the pins 140 into engagement with the first notches 182 of the slots 180 (see FIG. 2). The spring 150 may have one end connected with the connecting member 134 of the actuator 132 and an opposite end connected with the pivot shaft 70. Accordingly, the spring 150 acts to ensure that the pins 140 of the actuator 132 are engaged with the first notches 182 of the slots 180 when the mounting bracket 54 is in the driving position.

During movement of the support 24 into the desired position relative to the mounting bracket 54, the mounting bracket remains in the driving position abutting the base member 160, i.e., in a fixed position relative to the vehicle frame. More specifically, the pins 140 remain locked with the first notches 182 of the slots 180 in the mounting bracket 54 throughout movement of the support 24 relative to the mounting bracket. Once the support 24 is locked in the desired position relative to the mounting bracket 54, the steering wheel is positioned away from the vehicle dashboard and close to the operator in a driving-ready condition. Since the bias of the spring 150 and the frictional engagement between the pins 140 and the surfaces defining the first notches 182 of the slots 180 lock the mounting bracket 54 in the driving position relative to the base member 160 and the vehicle frame, the operator can operate the vehicle in this condition without any relative movement between the support 24, the mounting bracket, the base member, and the vehicle frame.

If, however, the operator wishes to egress the vehicle, the memory mechanism 130 can be used to permit movement of the mounting bracket 54, the support 24, and, thus, the steering column out of the way and into a stored position closer to the dashboard. This movement may likewise be desired for vehicle ingress by the operator. To utilize the memory mechanism 130, the operator grasps the handle 133 on the actuator 132 and pulls the handle in a downward direction, indicated at A (FIG. 4), away from the steering wheel. When the handle 133 is pulled downward, the pins 140 on the actuator 132 are pulled in a direction away from the first notches 182 of the slots 180. When the force upon the pins 140 exceeds a predetermined amount, the spring bias of the spring 150 and the frictional engagement between the pins 140 and the surfaces defining the first notches 182 of the slots 180 are overcome. This causes the pins 140 to disengage or become unlocked from the first notches 182 of the slots 180.

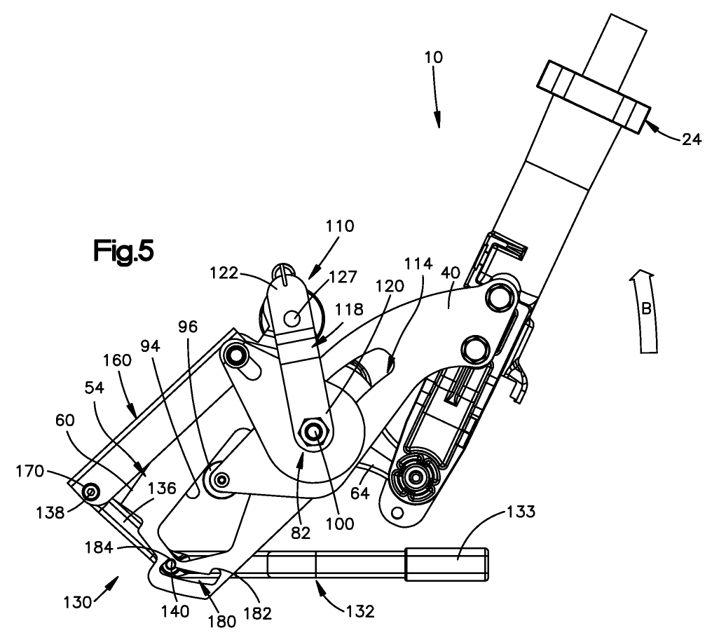

The configuration of the remainder of the slot 180 between the first and second notches 182, 184 allows the pins 140 to move freely along the slots relative to the mounting bracket 54. Accordingly, when the pins 140 are positioned between the first and second notches 182, 184, the mounting bracket 54 is no longer rigidly secured to the actuator 132 or the base member 160. The mounting bracket 54 is therefore capable of moving relative to the actuator 132, the base member 160, and, thus, the vehicle frame. In particular, the mounting bracket 54 is free to pivot about the pivot shaft 70 relative to the base member 160. Since the support 24 and the steering wheel are secured to the mounting bracket 54, movement of the mounting bracket relative to the base member 160 and, thus, the vehicle frame, likewise results in relative movement of the steering wheel relative to the vehicle frame. To rotate the mounting bracket 54 relative to the vehicle frame, the operator applies an upward force to the mounting bracket or the support 24 about the pivot shaft 70 in the direction indicated at B (FIG. 5). This causes the mounting bracket 54 to pivot upwards and away from the vehicle frame.

Although the pins 140 are unlocked from the first notches 182 of the slots 180 in the mounting bracket 54, the pins are still confined to movement within the slots. The movement of the mounting bracket 54 relative to the base member 160 and the vehicle frame, therefore, is limited to the profile of the slots 180. In particular, the extent of pivotal movement of the mounting bracket 54 about the pivot shaft 70 relative to the vehicle frame is defined between the first and the second notches 182,184 of the slots 180. The second notches 184 of the slots 180 thereby define the extent to which the mounting bracket 54 can be rotated away from the vehicle frame.

The mounting bracket 54 can be pivoted upwards away from the vehicle frame until the pins 140 adjoin the second notches 184 of the slots 180. Similar to the first notches 182, the second notches 184 of the slots 180 are constructed to resist entry or exit of the pins 140. When a predetermined amount of upward force applied to the mounting bracket 54 is exceeded, the frictional engagement between the pins 140 and the second notches 184 of the slots 180 is overcome to allow the pins 140 to enter, and become locked in, the second notches. As with the first notches 182 of the slots 180, this locking condition of the pins 140 with the second notches 184 prevents movement of the actuator 132 relative to the mounting bracket 54 and, thus, prevents movement of the mounting bracket relative to the vehicle frame. Furthermore, the spring 150 biases the pins 140 of the actuator 132 into the locked position with the second notches 184 of the slots 180.

When the pins 140 are locked in the second notches 184 of the slots 180, the mounting bracket 54 is locked in a second, stored position pivoted upwards away from the vehicle frame. Since this stored position places the steering column closer to the vehicle dashboard, there is additional space in the passenger compartment of the vehicle to facilitate vehicle ingress or egress by the operator.

If the operator desires to return the mounting bracket 54 to the first, driving position abutting the base member 160, the process described is reversed. In particular, the handle 133 on the actuator 132 is pulled downwards until the pins 140 on the actuator 132 disengage and unlock from the second notches 184 of the slots 180 in the mounting bracket 54. This again permits the mounting bracket 54 to move relative to the actuator 132, the base member 160, and the vehicle frame. The operator can then pull the steering wheel away from the dashboard to rotate the mounting bracket 54 downward towards the base member 160. As the mounting bracket 54 is rotated downward, the pins 140 on the actuator 132 travel from the second notches 184 of the slots 180 towards the first notches 182 until the pins 140 engage and lock with the first notches. This returns the mounting bracket 54 to the driving position abutting the base member 160 to place the steering wheel closer to the operator.

Although the memory mechanism 130 has been described as providing two positions into which the mounting bracket 54 and, thus, the steering wheel can be locked relative to the vehicle frame, i.e., a first or driving position and a second or stored position, those having ordinary skill will appreciate that the memory mechanism may be provided with means to lock the mounting bracket in more positions. For example, the slots 180 in the side walls 58, 60 of the mounting bracket 54 may be provided with third notches, fourth notches, etc. between the first and second notches 182,184 such that the pins 140 on the actuator 132 can be locked in any number of intermediate positions between the first and the second notches. Accordingly, the mounting bracket 54 and, thus, the steering wheel can be locked in any number of positions relative to the vehicle frame and dashboard.

Furthermore, although the memory mechanism 130 has been described for use with an exemplary steering column 10, it is contemplated that the memory mechanism may be used with any desired steering column. More specifically, the memory mechanism 130 may be used with a steering column having any desired locking mechanism. The memory mechanism 130 may also be used with steering columns having only tilt capabilities, only telescoping capabilities, fully adjustable steering columns, or steering columns that do not adjust relative to the mounting bracket.

From the above description of the invention, those skilled in the art will perceive improvements, changes and modifications. Such improvements, changes and modifications within the skill of the art are intended to be covered by the appended claims.

Having described the invention, the following is claimed:

1. A steering column for a vehicle comprising:
a steering column member connectable with a steering wheel and rotatable to turn steerable vehicle wheels;
a mounting bracket;
a support connected with the mounting bracket and through which the steering column member extends, the support supporting the steering column member for rotation about a longitudinal axis of the steering column member, the support being movable relative to the mounting bracket into any one of a plurality of positions;
a locking mechanism that locks the support in any one of the plurality of positions relative to the mounting bracket; and
a memory mechanism spaced from the locking mechanism for permitting movement of the mounting bracket relative to the vehicle frame between a first position and a second position, the memory mechanism guiding movement of the mounting bracket relative to the vehicle frame between the first position and the second position.

2. A steering column as set forth in claim 1 wherein the memory mechanism includes a base member connecting the mounting bracket to the vehicle frame and an actuator for selectively locking the mounting bracket in the first position or the second position.

3. A steering column as set forth in claim 2 wherein the mounting bracket has a slot into which a pin of the actuator extends, the pin moving relative to the mounting bracket along the slot.

4. A steering column as set forth in claim 3 wherein the slot includes a first notch and a second notch spaced from the first notch, the pin of the actuator engaging the first notch of the slot when the mounting bracket is in the first position and engaging the second notch of the slot when the mounting bracket is in the second position.

5. A steering column as set forth in claim 4 wherein the pin locks the mounting bracket in the first position when the pin engages the first notch of the slot, the pin locking the mounting bracket in the second position when the pin engages the second notch of the slot.

6. A steering column as set forth in claim 4 wherein the pin is biased into engagement with the first notch of the slot when the mounting bracket is in the first position, the pin being biased into engagement with the second notch of the slot when the mounting bracket is in the second position.

7. A steering column as set forth in claim 2 wherein the mounting bracket abuts the base member when the mounting bracket is in the first position, the mounting bracket being spaced from the base member when the mounting bracket is in the second position.

8. A steering column as set forth in claim 1 wherein the locking mechanism has an unlocked position that allows the support to move relative to the mounting bracket into any one of the plurality of positions, the locking mechanism having a locked position that locks the support in any one of the plurality of positions relative to the mounting bracket.

9. A steering column as set forth in claim 1 wherein the second position is any one of a plurality of positions of the mounting bracket relative to the vehicle frame different from the first position.

10. A steering column as set forth in claim 1 wherein a pivot member is pivotally connected to the mounting bracket and the support is pivotally connected to the pivot member, the pivot member pivoting relative to the mounting bracket and the support pivoting relative to the pivot member to place the support into any one of the plurality of positions.

11. A steering column as set for in claim 10 wherein the locking mechanism prevents pivotal movement of the pivot member relative to the mounting bracket and pivotal movement of the support relative to the pivot member to lock the support in any one of the plurality of positions relative to the mounting bracket.

12. A steering column for a vehicle comprising:
a steering column member connectable with a steering wheel and rotatable to turn steerable vehicle wheels;
a mounting bracket including slots, each slot having a first notch and a second notch spaced from the first notch;
a support connected with the mounting bracket and through which the steering column member extends; and
a memory mechanism comprising:
a base member connecting the mounting bracket to a vehicle frame; and
an actuator pivotally mounted to the base member, the actuator having a pin positioned within each slot on the mounting bracket, the pins being moveable along the slots to allow the mounting bracket to move relative to the base member, the pins engaging the first notches of the slots to lock the mounting bracket in a first position abutting the base member, the pins engaging the second notches of the slots to lock the mounting bracket in a second position spaced from the base member and different from the first position, the actuator being pulled away from the mounting bracket to move the pins out of engagement with the first or second notches of the slots to permit movement of the mounting bracket between the first position and the second position.
